(19) United States
(12) Patent Application Publication
(10) Pub. No.: US 2013/0204540 A1
(43) Pub. Date: Aug. 8, 2013

(54) METHOD FOR CONDITIONING SIGNALS FOR A COLLECTING PARTICLE SENSOR

(71) Applicant: Robert Bosch GmbH, Stuttgart (DE)

(72) Inventors: Andreas Genssle, Musberg (DE); Enno Baars, Leonberg (DE); Bernhard Kamp, Ludwigsburg (DE); Cornelia Nagel, Stuttgart (DE); Markus Eitel, Besigheim (DE)

(73) Assignee: ROBERT BOSCH GMBH, Stuttgart (DE)

(21) Appl. No.: 13/755,123

(22) Filed: Jan. 31, 2013

(30) Foreign Application Priority Data
Feb. 3, 2012 (DE) 102012201594.9

(51) Int. Cl. G01M 15/10; G06F 17/00

(52) U.S. Cl. CPC G01M 15/102; G06F 17/00
USPC 702/32; 73/114.71

(57) ABSTRACT

A method for conditioning an output signal of a collecting particle sensor in the exhaust gas duct of an internal combustion engine. The method including continuously storing values of the output signal in a memory, selecting a predetermined number of the stored values of the output signal, and conditioning the output signal based on the selected stored values.

### BACKGROUND OF THE INVENTION

The invention relates to a method for conditioning an output signal of a collecting particle sensor in the exhaust gas duct of an internal combustion engine.

The invention also relates to a method for conditioning an output signal of a collecting particle sensor in the exhaust gas duct of an internal combustion engine, wherein the output signal is filtered by means of a low-pass filter with a predefined time constant.

Particle sensors are used nowadays, for example, for monitoring the emission of soot by internal combustion engines and for on-board diagnostics (OBD), for example for functionally monitoring particle filters. In this context, collecting, resistive particle sensors are known which evaluate a change in the electrical properties of an inter-digital electrode structure on the basis of particle deposits. The particle sensors are arranged here downstream of the particle filter to be monitored in the exhaust gas stream. If the particle filter is fully loaded or the filtering effect is restricted, particles which come about during the combustion pass through the particle filter and are deposited on the particle sensor, which is proven by the described evaluation of the output signal of the particle sensor. During the regeneration of the particle sensor, as is necessary from a certain load state of the particle sensor, said particle sensor is heated by an integrated heating element to such an extent that the deposited soot particles burn and the particle sensor is ready for a subsequent measurement cycle.

Such a resistive particle sensor is described in DE 101 33 384 A1. The particle sensor is constructed from two comb-like electrodes (inter-digital electrodes) which engage one in the other and are at least partially covered by a capturing sleeve which serves to improve the depositing of particles. If particles are deposited on the particle sensor from a stream of gas, this leads to a change in the impedance of the particle sensor which can be evaluated, and from which the quantity of deposited particles and therefore the quantity of particles carried along in the exhaust gas can be determined. The sensor signal is evaluated, for example, by applying an electrical voltage to the particle sensor and by measuring the current through the sensor. In a first phase of the depositing, no current flows in this context since there are still no bridges of particles formed between the electrodes. The current subsequently rises until it reaches a predetermined threshold value, the triggering threshold. By comparison of a setpoint triggering time and an actual sensor triggering time it is possible to assess to what extent the loading of the stream of exhaust gas with particles undershoots or exceeds a predetermined threshold. The setpoint triggering time is determined here from a signal behavior model including a raw emission model of the internal combustion engine for particles. The actual sensor triggering time corresponds to the period of time from regeneration of the particle sensor up to the time when a predefined current threshold is reached, such as occurrs when there is corresponding loading of the particle sensor with soot and there is a voltage applied between the electrodes. The predefined current threshold is referred to as the triggering threshold of the particle sensor. In order to bring about a short response time of the sensor a current threshold is selected which is as low as possible. However, as a result the system is particularly sensitive to signal interference. If such signal interference occurs, the current threshold may be prematurely exceeded for a brief time, the particle content in the exhaust gas is estimated as being too high and the particle filter is incorrectly categorized as being defective. According to the prior art the signal of the particle sensor is therefore filtered by means of a low-pass filter with a long time constant. However, this procedure reduces the dynamics of the current signal, and leads to incorrect assessment owing to the slowed-down rise in the sensor signal itself.

According to the prior art, methods for checking the plausibility of the sensor signal which overcome constant interference, such as shunts, are known. DE 102007047081 discloses a method for detecting a degree of contamination of a particle sensor. DE 102009046315 discloses a method for operating a particle sensor, wherein the particle sensor has on its surface at least two inter-digital electrodes which engage one in the other and to which a sensor voltage U_IDE is at least temporarily applied in order to determine the loading of the particle sensor with soot particles, and a sensor current I_IDE across the electrodes is measured and evaluated, wherein in order to remove the loading with soot it is additionally possible to provide a heating element with which the particle sensor is heated in a regeneration phase. According to the invention, if the heating element is not activated when the sensor voltage U_IDE supplied, the conductivity of the soot particles or of the soot paths is determined. As a result, shunts can be detected and taken into account.

Furthermore, document R.331795 by the Applicant discloses a method for monitoring a resistive particle sensor on a shunt, wherein a temperature dependence of a measurement signal of the resistive particle sensor, which signal is dependent on the load state of the resistive particle sensor, is corrected on the basis of a temperature dependence of the electrical resistance of deposited soot particles by means of temperature compensation, and a temperature-compensated measurement signal is formed. The method is characterized in that during a measurement cycle of the particle sensor a change in the temperature-compensated measurement signal of the particle sensor over time is repeatedly determined, and in that a shunt is inferred if the change in the temperature-compensated measurement signal over time exceeds or undershoots a predefined tolerance range. Furthermore, an associated device is known from the document.

The object of the invention is therefore to make available a method which permits the output signal of a particle sensor to be evaluated with good suppression of interference signals but while largely maintaining the dynamics of the sensor signal.

### SUMMARY OF THE INVENTION

The object of the invention with respect to the method is achieved in that values of the output signal are continuously stored in a memory, in that in order to condition the output signal a selection is made from a predetermined number of the values last written into the memory, and in that for the selection the smallest value is selected from the predetermined number of values, or in that for the selection a number of smallest values from the predetermined number of values are not taken into account, or in that for the selection a number of largest values from the predetermined number of values are not taken into account, or in that for the selection each of the abovementioned criteria are considered per se or are used in combination. As a result of the fact that individual deviating values or groups of deviating values are not taken into account in the evaluation, temporary interference of the output signal of the collecting particle sensor can be gated out, such as can occur as a result of cross-sensitivity of the particle sensor with respect to other conductive exhaust gas components as the soot particles to be detected. The procedure does not reduce the dynamics of the signal, such as occurs during the low-pass filtering according to the prior art. The number of values to be held in the memory is determined by the intended chronological resolution and the period of time for which interference can occur. The number of values which are not to be taken into account is also determined from the chronological resolution and the duration of interference.

If the selected values are averaged in a weighted fashion for the conditioning of the output signal, good dynamics can be achieved by weighting the values stored last more strongly, and at the same time undesired fluctuations are nevertheless removed from the measurement signal. In the simplest embodiment, all the values which are taken into account are weighted equally.

In one preferred embodiment, the selection from the predetermined number of the values last written into the memory comprises a duration of the profile of the output signal of the collecting particle sensor, which is longer than the duration of an interference signal to be suppressed. In this case, the values from the memory can bridge the interference signal.

If the time constant is predefined as a function of the value of the output signal, it is possible to ensure that the dynamics of the output signal in the region near to the triggering threshold are largely maintained, but interference can still be reliably filtered out during a large part of the measurement cycle of the particle sensor.

In one preferred configuration of the method, at high values of the output signal, the time constant is reduced in comparison with time constants at low values of the output signal. As a result it is possible to ensure that interference signals are damped strongly well before the triggering threshold of the particle sensor, but in the vicinity of the triggering threshold the conditioned output signal has approximately the same dynamics as the untreated output signal of the particle sensor. In this way it is possible to largely avoid a possible delay in reaching the triggering threshold.

The probability of occurrence of interference depends on the operating parameters of the internal combustion engine. For example, in the case of a large mass flow of exhaust gas or in the case of strong dynamics of the mass flow of exhaust gas the probability of interference is particularly high. It is therefore advantageous to predefine the time constant as a function of operating parameters of the internal combustion engine. As a result, the dynamics of the output signal can be largely maintained in phases with a low probability of interference.

The time constant can be adapted in an optimum way to the occurrence of interference which is dependent on the operating parameters of the internal combustion engine, and to the level of the output signal, by predefining the time constant according to a characteristic curve.

Interference can be gated out particularly well while largely maintaining the signal dynamics by virtue of the fact that values of the output signal are continuously stored in the memory, that in order to condition the output signal a selection is made from the predetermined number of the values last written into the memory, that the selected values are filtered with the low-pass filter, and that the time constant of the low-pass filter is predefined as a function of the selected values.

The method according to the invention is particularly well suited for use in conditioning the output signal of a resistive particle sensor. Such a resistive particle sensor can be used, in particular, for evaluating the filter effect of a particle filter in the exhaust gas duct of an internal combustion engine. It is advantageous here largely to retain the dynamics of the output signal of the resistive particle sensor since the duration from the start of a measurement cycle up to the time when the triggering threshold is reached is the measure of the filter effect, and it is necessary to avoid characterizing particle filters incorrectly as intact or faulty.

### BRIEF DESCRIPTION OF THE DRAWINGS

The invention will be explained in more detail below with reference to exemplary embodiments illustrated in the figures. In the drawings:

FIG. 1 shows a signal profile at a particle sensor with an interference signal,

FIG. 2 shows the signal profile at the particle sensor from the start of measurement up to the trigging threshold,

FIG. 3 shows the signal profile at the particle sensor at the triggering threshold, and

FIG. 4 shows a flowchart for implementation of the conditioning of signals.

### DETAILED DESCRIPTION

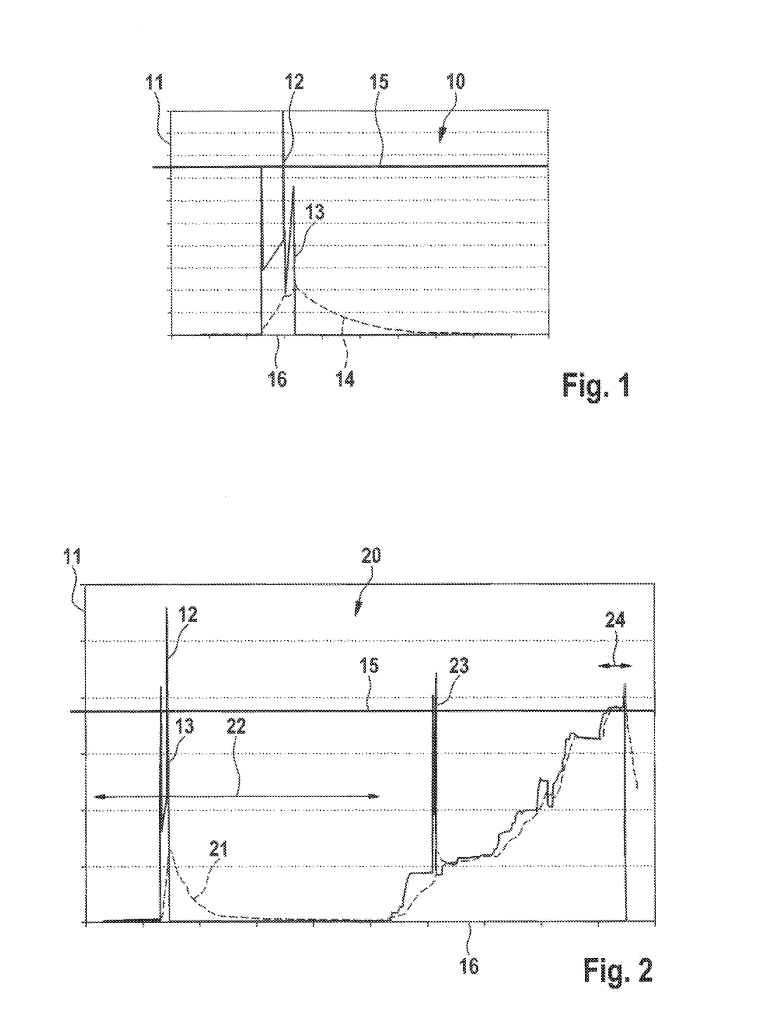

FIG. 1 shows, in a first signal diagram 10, a sensor signal 13 which is a current profile in a first measurement phase of a resistive particle sensor, in which measurement phase first particles are deposited on the particle sensor. During this measurement phase, soot bridges are not yet formed between the comb-like electrodes of the particle sensor, with the result that when an electrical voltage is applied current still cannot flow. The sensor signal 13 is applied along a time axis 16 and a signal axis 11. For the arrangement, a triggering threshold 15 is predetermined, which triggering threshold 15 corresponds to a current at which the particle sensor is considered to be loaded with particles to such an extent that it can output a reliable signal about the load state. The duration between the start of the measurement and the time when the triggering threshold 15 is reached characterizes the proportion of particles in the exhaust gas. The triggering threshold 15 is already briefly exceeded by an interference signal at the time of a first signal upward transgression 12. Without further signal processing, the triggering threshold 15 would in this case be exceeded too early by a significant degree and would incorrectly indicate an excessively high proportion of particles in the exhaust gas. This could lead to a situation in which a particle filter which is mounted upstream of the particle sensor in the exhaust gas duct would be erroneously categorized as defective. According to the prior art, the sensor signal 13 is therefore filtered with a low-pass filter, with the result that the profile of a low-pass-filtered sensor signal 14 is set. The low-pass-filtered sensor signal 14 does not reach the triggering threshold 15 in the case illustrated, and a false alarm can therefore be avoided.

FIG. 2 shows, in a second signal diagram 20, the sensor signal 13 during a complete measurement cycle of the particle sensor from the start with the particle sensor which has been burnt clean up to the usual reaching of the triggering threshold 15 in a triggering region 24, which indicates in terms of timing when the triggering threshold 15 is exceeded. The same terms as those in FIG. 1 are characterized by the same numbers. In addition to the sensor signal 13, a sensor signal 21 which is conditioned according to the invention is indicated. In a first measurement phase 22, the sensor collects particles without them already forming bridges of soot particles which permit a flow of current. Nevertheless, the triggering threshold 15 is exceeded as a result of interference signals during the first signal upward transgression 12 and in the further profile after the first measurement phase 22 in the case of a second signal upward transgression 23 of the sensor signal 13. The conditioned sensor signal 21 does not exceed the triggering threshold 15, and the indication of an excessively high concentration of particles is avoided.

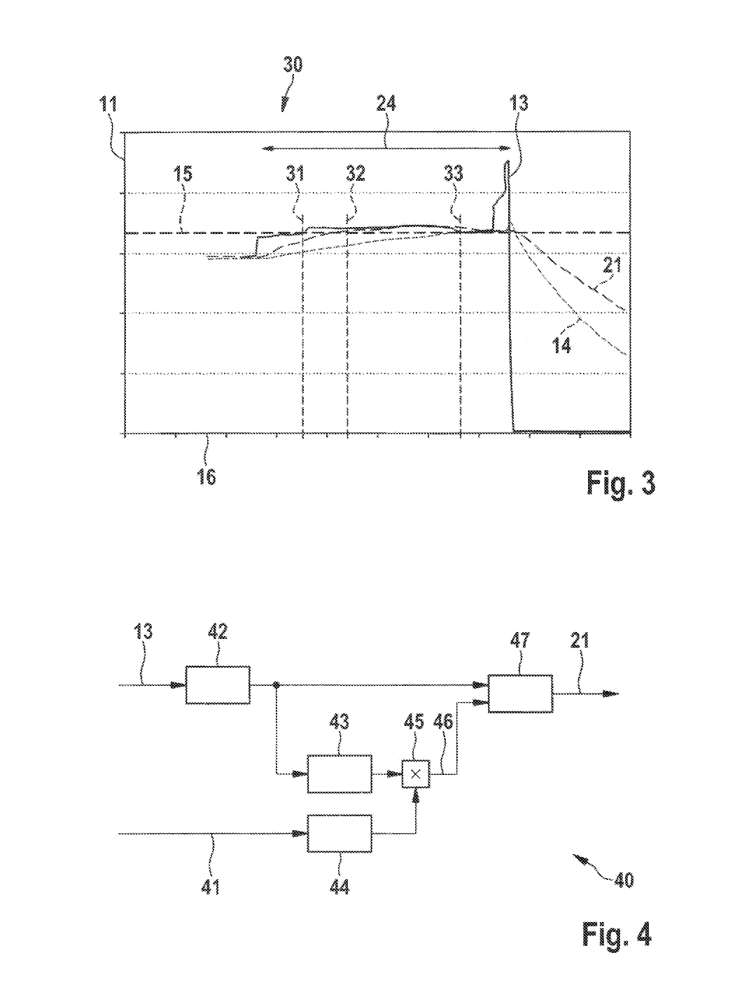

FIG. 3 shows, in a third signal diagram 30, the signal profile in the vicinity of the triggering region 24. The sensor signal 13 exceeds the triggering threshold 15 at the first triggering time 31. The low-pass-filtered sensor signal 14 reaches the triggering threshold 15 substantially later at the third triggering time 33; in this case the low-pass filtering causes the particle concentration in the exhaust gas to be underestimated. The sensor signal 21 which is conditioned according to the invention reaches the triggering threshold 15 at the second triggering time 32, which is just after the first triggering time 31 for the unconditioned sensor signal 13. The improvement of the conditioned sensor signal 21 is achieved in that the sensor signal 13 is continuously fed to a memory, and in each case a number of smallest values of a predetermined number of measured values is fed for further evaluation. Alternatively, a number of smallest and largest values can be ignored and the remaining values averaged. The remaining value stream is subjected to low-pass filtering, wherein the time constant is dependent on the level of the values, with the result that in the vicinity of the triggering threshold 15 only a slight delay of the conditioned sensor signal 21 occurs compared to the sensor signal 13.

FIG. 4 shows, in a flow chart 40, the generation of the conditioned sensor signal 21 from the sensor signal 13. The sensor signal 13 is fed to a minimum value formation means 42 in which a predetermined number of values of the sensor signal 13 are buffered, and a selection of the small values is averaged and output. For an update, all the values are respectively shifted by one memory location and a new value is placed in the memory. The result of the minimum value formation means 42 is fed to a low-pass filter 47 whose time constant can be set via an input 46. The output signal of the minimum value formation means 42 is also fed to a first characteristic curve 43 with which the time constant of the low-pass filter 47 can be influenced as a function of the level of the output signal. Operating parameters 41 of the internal combustion engine are fed to a second characteristic curve 44 in order to be able to increase the time constant of the low-pass filter 47 if an increased probability of signal interference is to be expected. This is to be expected, for example, in the case of a large mass flow of exhaust gas or in the case of strong dynamics of the mass flow of exhaust gas. The output signals of the first characteristic curve 43 and of the second characteristic curve 44 are fed via a multiplication stage 45 to the input 46 of the low-pass filter 47 in order to set the time constant thereof

1. A method for conditioning an output signal of a collecting particle sensor in an exhaust gas duct of an internal combustion engine, the method comprising:
continuously storing values of the output signal in a memory;
selecting a predetermined number of the stored values of the output signal; and
conditioning the output signal based on the selected stored values.

2. The method according to claim 1, wherein the selected stored values include the smallest of the stored values.

3. The method according to claim 1, wherein the selected stored values exclude a number of the smallest of the stored values.

4. The method according to claim 1, wherein the selected stored values exclude a number of the largest of the stored values.

5. The method according to claim 1, wherein the selected stored values include the smallest of the stored values, exclude a number of the smallest of the stored values, and exclude a number of the largest of the stored values.

6. The method according to claim 1, wherein the predetermined number of stored values include two or more of the criteria of including the smallest of the stored values, excluding a number of the smallest of the stored values, and excluding a number of the largest of the stored values.

7. The method according to claim 1, further comprising averaging, in a weighted fashion, the selected values to condition the output signal.

8. The method according to claim 1, characterized in that the selection from the predetermined number of the values last written into the memory comprises a duration of a profile of the output signal of the collecting particle sensor, the duration being longer than a duration of an interference signal to be suppressed.

9. The method according to claim 1, wherein values of the output signal are continuously stored in the memory, and the selected values are selected from the predetermined number of the values last written into the memory, and the selected values are filtered with a low-pass filter, a time constant of the low-pass filter predefined as a function of the selected values.

10. A method for conditioning an output signal of a collecting particle sensor in the exhaust gas duct of an internal combustion engine, the method comprising:
filtering the output signal by a low-pass filter with a predefined time constant;
wherein the time constant is predefined as a function of the value of the output signal.

11. The method according to claim 10, wherein the time constant, at high values of the output signal, is less than the time constants at low values of the output signal.

12. The method according to claim 10, wherein the time constant is predefined as a function of operating parameters of the internal combustion engine.

13. The method according to claim 10, wherein the time constant is predefined according to a characteristic curve.

14. The use of a method according to claim 1 for conditioning the output signal of a resistive particle sensor.
